(19) United States
(12) Patent Application Publication
(10) Pub. No.: US 2011/0265274 A1
(43) Pub. Date: Nov. 3, 2011

(54) Bridge Deck Replacement Machine and the Method of Bridge Deck Replacement Using the Same

(75) Inventor: Yabin Liu, Beijing (CN)

(73) Assignee: BEIJING WOWJOINT MACHINERY CO., Beijing (CN)

(21) Appl. No.: 12/771,370

(22) Filed: Apr. 30, 2010

(51) Int. Cl. B60P 1/02; E01D 21/06; E01D 21/00

(52) U.S. Cl. 14/77.1; 414/495

(57) ABSTRACT

This invention relates to a bridge deck replacement and transporting equipment, in particular, relates to a bridge deck replacement machine; in addition, this invention also relates to a method of bridge deck replacement using the same. In particular, a bridge deck replacement machine in this invention comprising a frame, bridge deck supporting means set on the top the frame, and a moving unit set under the frame; wherein, said bridge deck supporting means comprises a fixed bracket and a main lift cylinder; said main lift cylinder has a first end and a second end which is opposite to said first end; said first end of said main lift cylinder is in fixed connection with said frame, while said second end of said main lift cylinder is in fixed connection with the bottom surface of said fixed bracket; at least one connection saddle for fixedly connecting to a connecting girder is set on the side of said frame; said bridge deck replacement machine further comprises an electro-hydraulic control system, and said electro-hydraulic control system controls the movement of said bridge deck supporting means.

### TECHNICAL FIELD

This invention relates to a bridge deck replacement and transporting equipment, in particular, relates to a bridge deck replacement machine; in addition, this invention also relates to a method of bridge deck replacement using the same.

### BACKGROUND OF INVENTION

Replacing a bridge deck usually refers to removing or assembling a bridge deck. In ordinary construction of autobahn, an entire bridge deck is always divided into several parts, and each part of the bridge deck is removed by two cranes raising the lines bound at both ends of each part of the bridge deck. However, because of low capacity of the crane, an entire bridge deck needs to be divided into many parts, and this is high labour intensive, and may result in low work efficiency.

In addition, the ordinary way of removing a bridge deck is demolishing an old entire bridge deck. And the ordinary way of assembling a bridge deck can be pre-constructing a bridge deck body in a different location, and then moving the bridge deck body pre-constructed to the construction site. Ordinarily, a large flatbed equipped with a driving force system, hydro-cylinder and load-bearing mechanism is used for replacement and transportation. However, this kind of flatbed is not special for bridge deck replacement and transportation. There exit some disadvantages:
(1) The entire system of said flatbed is very complex; specifically, the procedure of assembling said flatbed is very complex, and a crane is also needed for assembling; furthermore, several control systems and driving force systems are needed for ascending and descending and balance control.
(2) It takes too much time to debug the system, and it is also difficult and inconvenient to manipulate said flatbed.
(3) A special arrangement is needed for transporting from a place to another using said flatbed, because of its large size.
(4) When transporting a bridge deck with a huge length using said flatbed, several flatbeds shall be connected to one another, in order to bear the bridge deck body. The bridge deck body becomes the connection supporter of every two said flatbeds. Therefore, it is not suitable for distant transportation. Moreover, it is inconvenient for transporting a bridge deck with huge width.
(5) The cost of transportation is very high.

In order to solve the problems of transporting the large tonnage object, some improvements have been made on the existing transporting machines. Chinese patent (Publication No. CN2734699Y) introduces an assembling and transporting machine with large tonnage, including a transporting machine, spandrel girder, slipping bar, bracket, transition girder, and pillars; wherein the pillars located on the ground are arranged under the spandrel girder for supporting said spandrel girder; said spandrel girder is equipped with said slipping bar on its upside; the bracket is arranged on the slipping bar, mechanically connected to said spandrel girder; the object with large tonnage is put on the bracket. After that, said object can be transported to a location in distance for assembling. When it begins to transport said object, said spandrel girder has to be raised, then, a transporter shall be inserted into the room under said spandrel girder. There is a need for using more than one transporter to transport such large tonnage object, and the number of said transporters depends on the weight and size of the object to be transported. Said assembling and transporting machine has some disadvantages as follows:
(1) That the spandrel girder has to be raised and the transporter has to be inserted into the room under said spandrel girder may result in relative movement between said transporter and said spandrel girder; in addition, in order to raise said spandrel girder, a large power driving force system becomes necessary.
(2) When transporting a large tonnage object, several transporters shall be used. In this situation, the synchronization of the movement of all the transporters used can hardly be kept, which may also affect the normal transportation.
(3) As the spandrel girder, slipping bar, and transition girder can not move up and down, said assembling and transporting machine is not suitable for removing and assembling a bridge deck.

A large tonnage transporter usually has more wheels than a light van has, the wheels of said large tonnage transporter are arranged in terms of several parallel rows, and each row has several sets of wheels. This may allow decentralize the weight of the transporter through a relatively large number of wheels. When the transporter is at empty load, some of the wheels of said transporter can be lifted up to get separated from the ground, in order to reduce the friction force and improve the speed. Chinese patent (Publication No. CN1887632A) introduces a wheel mechanism of a large tonnage transporter, including a frame of transporter, wheels, fixed pole of frame, connecting axis of wheels, and elastic steel plate set; wherein said connecting axis of wheels are connected to said elastic steel plate set through a connecting device. A movable connecting device is arranged between each two elastic steel plates. The elastic steel plate has the first end and the second end. The first end of said elastic steel plate is articulated with said fixed pole of frame, and the second end of said elastic steel plate is hitched upon one of the ends of the connecting device. The fulcrum of the movable connecting device is in flexible connection with the frame of transporter, and the other end of the connecting device is connected to one of the ends of a lifting gear of wheel, while the other end of the lifting gear of wheel is articulated with the frame of transporter. The lifting device of wheel is equipped with a spring means. When the transporter is on load, the spring means is compressed due to large weight, each set of wheels get in touch with the ground; and when the transporter is at empty load, the extent of compression of spring means is reduced due to relatively small weight, and the wheel can be lifted up to be separated from the ground by the lifting device of wheel. US patent no. US20030176119A1 introduces a suspension system, wherein, a spring device is used to lift and land the assistant wheels according to the extent of compression due to the load. However, this kind of spring device can be easily broken, once the load exceeds the maximum spring force, so as to affect the normal use of such suspension system.

The U.S. Pat. No. 3,751,066 introduces a wheel suspension system, wherein the cradle gets up and down via an air spring for shock absorption. The kind of wheel suspension system can not keep the wheel suspended for a long time. Therefore, it is not suitable for suspending a large tonnage object.

### SUMMARY OF INVENTION

One of the objectives of this invention is to provide a bridge deck replacement machine that enables itself to be in transverse and/or longitudinal connection with other bridge deck replacement machines to constitute a bridge deck replacement machine unit, coordinating with the weight and size of the bridge deck needed to be removed and assembled or a bridge deck replacement machine unit constituted by said bridge deck replacement machine units, so as to realize the removal of said bridge deck from the piers and short distance transportation of said bridge deck. The size of a single bridge deck replacement machine meets the requirements of the ordinary road for the size of vehicle and can hardly affect the traffic. A tractor can be used to tow the bridge deck replacement machine unit or the bridge deck replacement machine group, in order to conduct long distance transportation of a huge-sized bridge deck. Each bridge deck replacement machine comprises an electro-hydraulic control system and load-bearing mechanism, which are easy to assemble and debug.

Another objective of this invention is to provide a bridge deck replacement machine unit constituted by above mentioned bridge deck replacement machines.

A further objective of this invention is to provide a method of bridge deck replacement using said bridge deck replacement machine or said bridge deck replacement machine unit.

A final objective of this invention is to provide a bridge deck replacement machine group using the above mentioned method of bridge deck replacement.

A bridge deck replacement machine in this invention comprising a frame, bridge deck supporting means arranged on the top of the frame, and a moving unit arranged under the frame; wherein, said bridge deck supporting means comprises a fixed bracket and a main lift cylinder; said main lift cylinder has a first end and a second end which is opposite to said first end; said first end of said main lift cylinder is in fixed connection with said frame, while said second end of said main lift cylinder is in fixed connection with the bottom surface of said fixed bracket; at least one connection saddle for fixedly connecting to a connecting girder is arranged on the side of said frame; said bridge deck replacement machine further comprises an electro-hydraulic control system, and said electro-hydraulic control system controls the movement of said bridge deck supporting means.

The bridge deck replacement machine, wherein, said moving unit consists of at least two wheel mechanisms; said wheel mechanism comprises wheels, a connecting link mechanism arranged between the bottom surface of said frame and the axle of said wheel, and a balance hydro-cylinder for controlling the ascending and descending of the wheels of said wheel mechanism via controlling the movement of said connection link mechanism.

The bridge deck replacement machine, wherein, said connecting link mechanism comprises a upper cradle arranged on the bottom surface of said frame, and a lower cradle, the upper end of said lower cradle is in flexible connection with the lower end of said upper cradle; the lower end of said lower cradle is in flexible connection with said axle, and the upper end of said upper cradle is longitudinally articulated with said frame via a swing mechanism; one of the ends of said balance hydro-cylinder is in flexible connection with the upper end of said upper cradle, and the other end of said balance hydro-cylinder is in flexible connection with the lower end of said lower cradle.

The bridge deck replacement machine, wherein, said swing mechanism comprises a steering cylinder, a rotary disk and bearing supporter; said bearing supporter is fixed on the bottom surface of said frame, said rotary disk and said bearing supporter are in rotary connection with each other via a bearing; said upper cradle is fixed on said rotary disk; one of the ends of said steering cylinder is articulated with said rotary disk, while the other end of said steering cylinder is articulated with said frame via an abutment.

The bridge deck replacement machine, wherein, said connection saddle is a transverse connection saddle arranged on the transverse side of said frame for forming a transverse connection between each two bridge deck replacement machines.

The bridge deck replacement machine, wherein, said connection saddle is a longitudinal connection saddle set on the longitudinal side of said frame for forming a longitudinal connection between each two bridge deck replacement machines.

The bridge deck replacement machine, wherein, the number of said connection saddles is more than two, one of which is a transverse connection saddle set on the transverse side of said frame and the other of which is a longitudinal connection saddle set on the longitudinal side of said frame, for forming a transverse connection and a longitudinal connection among said bridge deck replacement machines.

A bridge deck replacement machine unit constituted by at least two above mentioned bridge deck replacement machines, wherein, said bridge deck replacement machine unit is constituted by at least two above mentioned bridge deck replacement machines fixedly connected to each other via said connecting girder; each end of said connecting girder is in fixed connection to the connecting saddle of adjacent said bridge deck replacement machine; said electro-hydraulic control system controls the ascending and descending of said bridge deck supporting means, or turning of said moving unit.

The bridge deck replacement machine unit, wherein, said electro-hydraulic control system controls the ascending and descending of said bridge deck supporting means, and turning of said moving unit.

The bridge deck replacement machine unit, wherein, said fixed connection is a removable connection.

A method of bridge deck replacement using the bridge deck replacement machine or the bridge deck replacement machine unit, wherein comprising the steps of:

a. controlling the working of each said main lift cylinder via said electro-hydraulic system to adjust the ascending and balance of said fixed bracket;

b. Jacking a bridge deck via said fixed bracket, in order to remove or assemble said bridge deck;

c. controlling the working of said main lift cylinder via said electro-hydraulic control system to adjust the descending and balance of said fixed bracket.

The method of bridge deck replacement, wherein, the number of said main lift cylinders is more than three; each said main lift cylinder is respectively connected to a first closed loop oil circuit via an oil circuit interface, forming a fixed bracket three-point balance supporting system; said electro-hydraulic control system controls the working of said main lift cylinder of said fixed bracket three-point balance supporting system to adjust the ascending, descending and balance of said fixed bracket.

The method of bridge deck replacement, wherein, the number of said balance hydro-cylinders is more than three; each said balance hydro-cylinder is respectively connected to a second closed loop oil circuit via an oil circuit interface, forming a frame three-point balance supporting system; said electro-hydraulic control system controls the working of said balance hydro-cylinders of said frame three-point balance supporting system to adjust the balance of said frame.

The method of bridge deck replacement using said bridge deck replacement machine or said bridge deck replacement machine unit; wherein,

At least two said bridge deck replacement machine units are connected to each other in parallel, constituting a bridge deck replacement machine group; at least one said bridge deck replacement machine unit is equipped with at least one tractor connector.

Said electro-hydraulic control system controls the ascending, descending and balance of said fixed bracket through controlling the working of said main lift cylinders of said fixed bracket three-point supporting system, in order to remove a bridge deck from the piers, or assemble a bridge deck on the piers.

Said electro-hydraulic control system also controls the balance of said frame through controlling the working of said balance hydro-cylinder of said frame three-point balance supporting system.

The present invention has some advantages as below:
(1) The bridge deck replacement machine introduced in this invention gains large scope of application. A number of said bridge deck replacement machines can be connected transversely or longitudinally together to constitute a bridge deck replacement unit or even a bridge deck replacement group through connecting saddles, in order to be able to remove and assemble a bridge deck with different sizes and weights. This invention also allows an entire bridge deck to be removed and assembled without being divided into several small parts, so as to ease the intensity of construction, shorten the time span of construction, and speed up the progress of construction.
(2) That the electro-hydraulic control system controls the ascending and descending of the bridge deck supporting means can help remove an old bridge deck and assemble a new bridge deck.
(3) The entire bridge deck replacement machine unit is obtained by connecting the bridge deck replacement machines together via the connecting saddle arranged on the sides of the machine, making it easy to assemble and disassemble, easy to use, thereby saving the time that has to be cost for debugging the equipment installed with the help of the auxiliary machines such as crane. A single bridge deck replacement machine is towed by a tractor, when running on the road. It realizes a facilitated and quick way for distant transportation. In a small construction site with very limited room to use, placing two said bridge deck replacement machines at each end of the bridge deck to remove the old bridge deck causes very little impact on the road, as there is no need to use the room in the middle of the road.
(4) The bridge deck on the bridge deck replacement machine driven by a tractor can be transported to a bridge deck factory. During the course of transportation, the size of said bridge deck replacement is still within the limitation (permitted maximum length, width, and height of an object of road). When the bridge deck replacement machine is at empty load, the wheels of said bridge deck replacement machine can be lifted up, through driving said connecting rod which is controlled by said electro-hydraulic control system, so that the number wheels used for running is reduced. Because less wheels are used, the running resistance is reduced, and it may improve the running speed, thereby shortening the time span of transportation.
(5) Each two said bridge deck replacement machines are fixedly connected together via said connecting girder, and this fixed connection is rigid fixed connection, which realizes a constant interval between each two adjacent said bridge deck replacement machines during the course of transportation. The electro-hydraulic control system of said bridge deck replacement machine may control the working of said hydro-cylinder when making a turn, wherein, the rotation angle of said replacement machine in place reaches up to 90 degree, and this makes said bridge deck replacement machine easy to turn, so as to facilitate its transverse and longitudinal movement.
(6) The bridge deck replacement machine introduced in this invention can realize a balance supporting system, wherein:

Each main lift cylinder is connected to a first closed loop oil circuit via an oil circuit interface, forming a fixed bracket balance supporting system under the circumstance that the number of said main lift cylinders is more than three; a electro-hydraulic control system controls the working of said main lift cylinders to adjust the ascending and balance of said fixed bracket; meanwhile, each said balance hydro-cylinder is connected to a second closed loop oil circuit, forming a frame balance supporting system under the circumstance that the number of said balance hydro-cylinders is more than three, and said electro-hydraulic control system controls the working of main lift cylinders to adjust the balance of the frame of said bridge deck replacement machine.
(7) The bridge deck replacement machine units and the bridge deck replacement machine group introduced in this invention can also realize a balance supporting system in terms of the way of working of above mentioned cylinders, in order to make it more stable when removing or transporting a bridge deck.

### BRIEF DESCRIPTION OF INVENTION

The above mentioned and other features and advantages of this invention, and the manner of attaining them, will become more apparent and the invention itself will be better understood by reference to the following description of preferred embodiments of this invention taken in conjunction with the accompanying drawings, wherein:

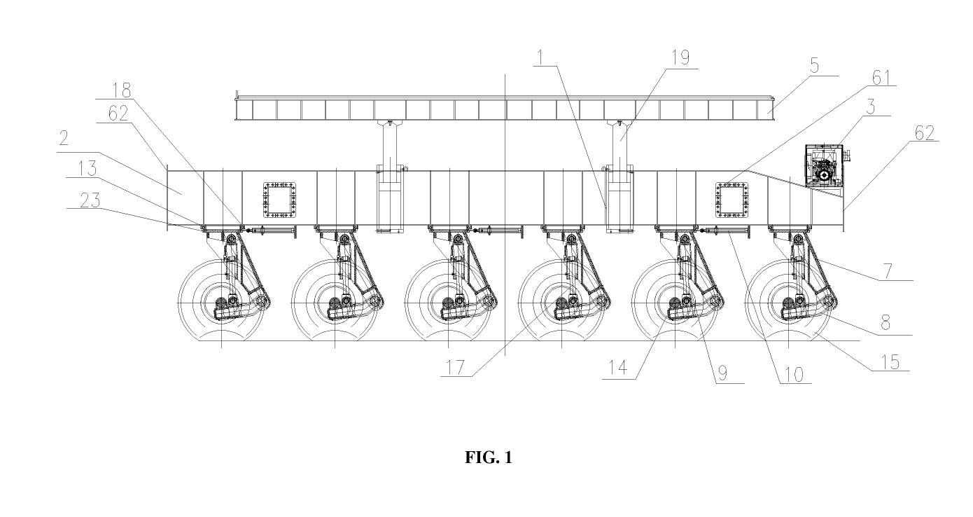

FIG. 1 is a main view of a bridge deck replacement machine;

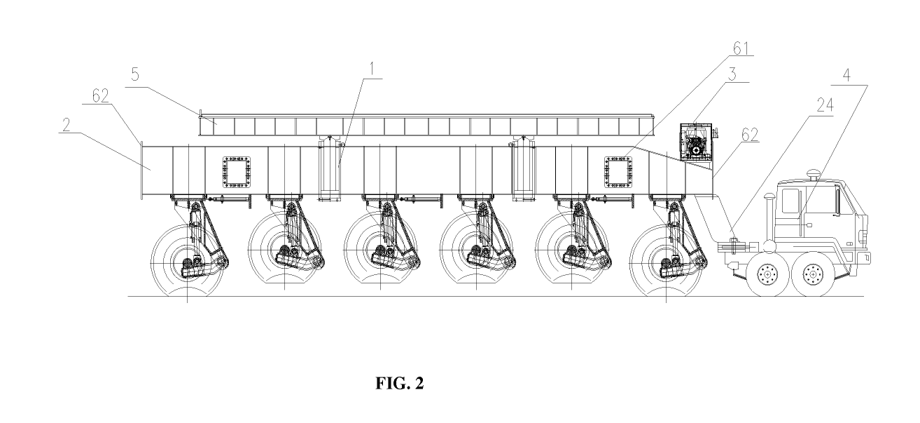

FIG. 2 is a view of a bridge deck replacement machine at empty load;

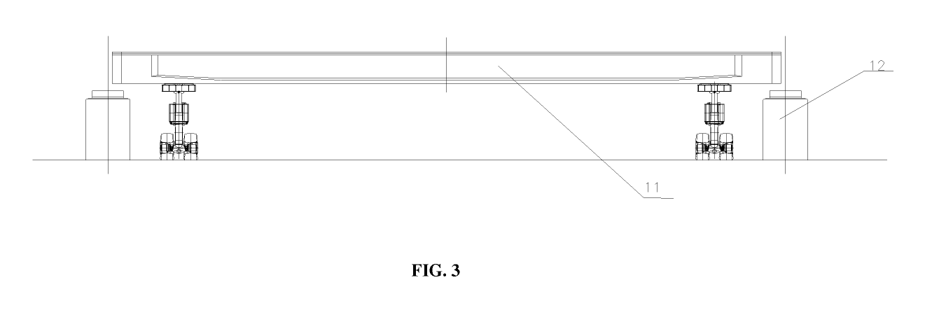

FIG. 3 is a main view of a bridge deck replacement machine in working status;

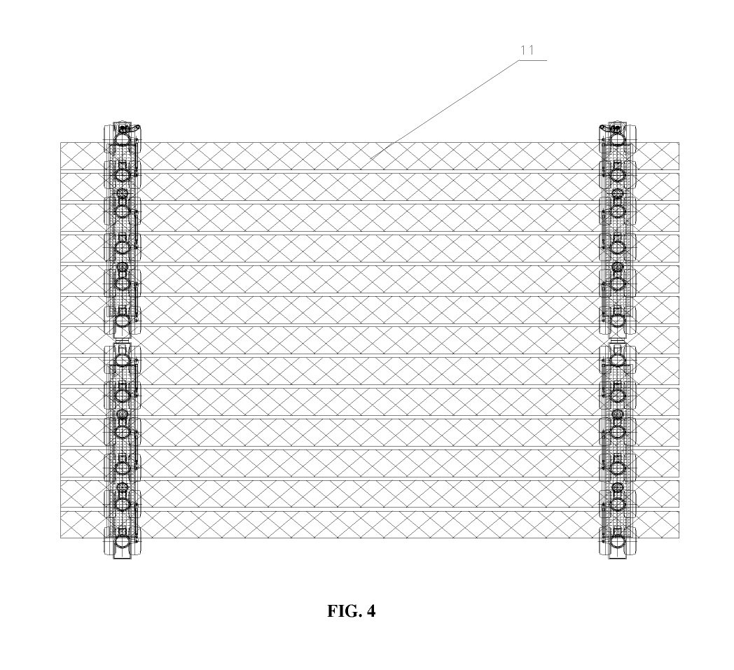

FIG. 4 is a vertical view of a bridge deck replacement machine in working status;

FIG. 5 is a vertical view of a bridge deck replacement machine unit constituted by two bridge deck replacement machines in transverse connection with each other;

FIG. 6 is a right side view of a bridge deck replacement machine unit constituted by two bridge deck replacement machines in transverse connection with each other;

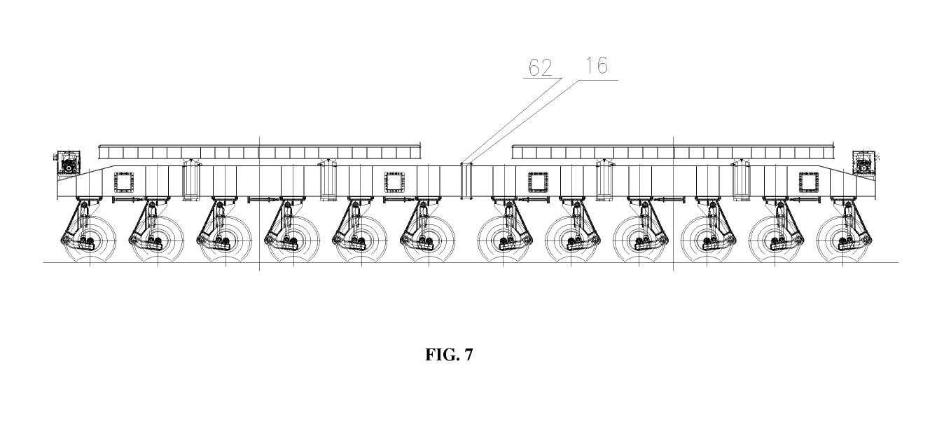

FIG. 7 is a main view of a bridge deck replacement machine unit constituted by four bridge deck replacement machines.

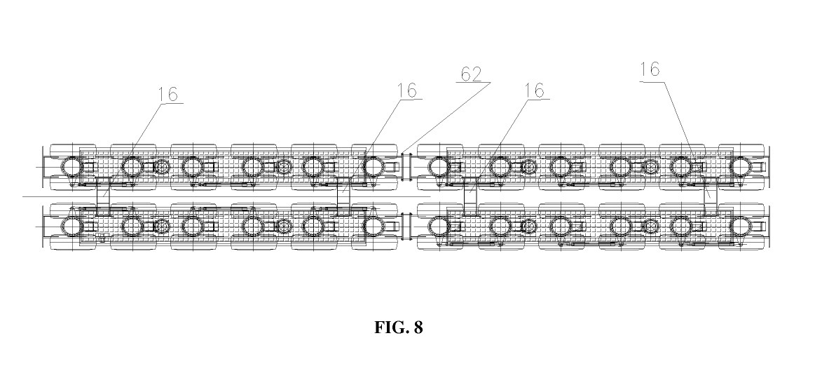

FIG. 8. is a vertical view of a bridge deck replacement machine unit constituted by four bridge deck replacement machines.

FIG. 9 is a view of a bridge deck replacement machine unit with the rotation angle of 0-90 degree.

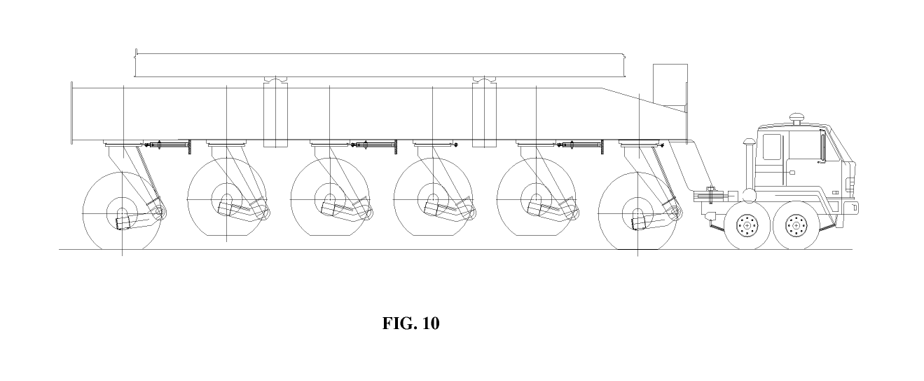

FIG. 10-FIG. 12 are the views of the bridge deck replacement machine group in working status

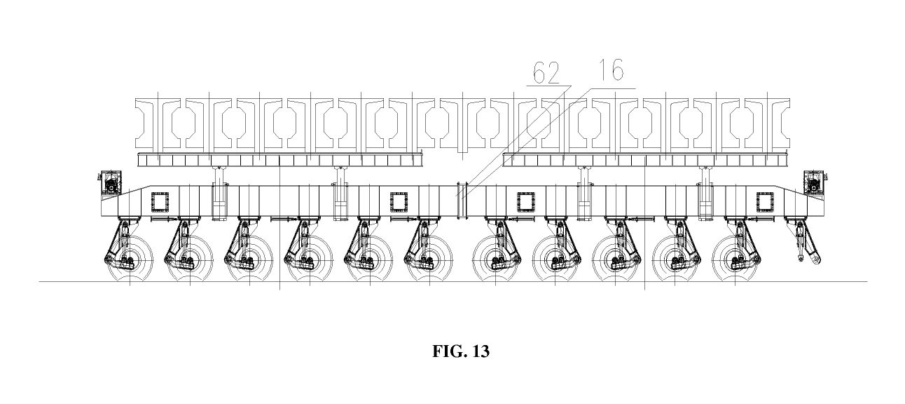

FIG. 13 is the sectional view of FIG. 12.

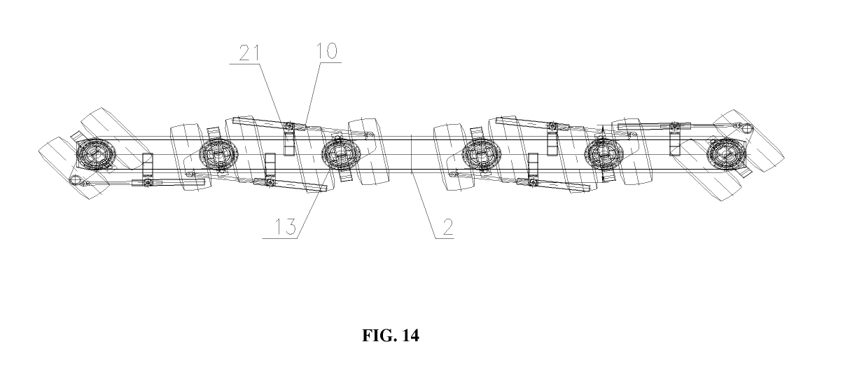

FIG. 14 is view of swing mechanism.

FIG. 15 is a view of a connection link mechanism and the swing mechanism.

1—main lift cylinder 2—frame 3—electro-hydraulic control system 4—tractor 5—fixed bracket 61—transverse connection saddle 62—longitudinal connection saddle 7—upper bracket 8—lower bracket 9—balance hydro-cylinder 10—steering cylinder 11—bridge deck 12—pier 13—bearing supporter 14—axle 15—wheel 16—connecting girder 17,18,19—piston rod 20—swing mechanism 21—abutment 23—rotary disk 24—Tractor connector

### PREFERRED EMBODIMENTS OF THIS INVENTION

### Example 1

Referring to FIG. 1, a bridge deck replacement machine, comprising a frame 2, a bridge deck supporting means arranged on the top of said frame 2, and a moving unit; said bridge deck replace machine has six sides which consists of a top surface and a bottom surface, two transverse sides opposite to each other, and two longitudinal sides opposite to each other.

Wherein, a transverse connection saddle 61 is set on the transverse side of said frame 2 for forming a transverse fixed connection between each two bridge deck replacement machines through the connecting girder 16 and the flanges. Alternatively, a longitudinal connection saddle 62 is arranged on the longitudinal side of said frame 2 for forming a longitudinal fixed connection between each two bridge deck replacement machines through the connecting girder 16 and the flanges.

Said bridge deck supporting means comprises a fixed bracket 5, and two main lift cylinders 1; said main lift cylinder 1 has a first end and a second end which is opposite to said first end; said first end of said main lift cylinder 1 is in fixed connection with said frame 2, while the piston rod 19 at said second end of said main lift cylinder 1 is in fixed connection with the bottom surface of said fixed bracket 5.

Said moving unit comprises six wheel mechanisms; each said wheel mechanism comprises two wheels 15, a connecting link mechanism arranged between the bottom surface of said frame 2 and the axle 14 of said wheel 15, and a balance hydro-cylinder 9 for controlling the ascending and descending of the wheels 15 of said wheel mechanism via controlling the extension and retraction of said connection link mechanism. All the six balance hydro-cylinders 9 are divided into three groups. Each group of balance hydro-cylinders 9 are connected to a second closed loop oil circuit. Each group of balance hydro-cylinders 9 are taken as a fulcrum, and the three groups of balance hydro-cylinders 9 form a frame three-point balance supporting system.

Said connecting link mechanism comprises a upper cradle 7 and a lower cradle 8 arranged on the bottom surface of said frame 2, the upper end of said lower cradle 8 is in flexible connection with the lower end of said upper cradle 7; the lower end of said lower cradle is in flexible connection with said axle 14, and the upper end of said upper cradle 7 is longitudinally articulated with said frame 2 via a swing mechanism 20; one of the ends of said balance hydro-cylinder 9 is in flexible connection with the upper end of said upper cradle 7, and the piston 17 at the other end of said balance hydro-cylinder 9 is in flexible connection with the lower end of said lower cradle 8. Referring to FIG. 14 and FIG. 15, said swing mechanism 20 can be a steering wheel, or a mechanism that comprises a steering cylinder 10, a rotary disk 23 and bearing supporter 13; said bearing supporter 13 is fixedly arranged on the bottom surface of said frame 2, said rotary disk 23 and said bearing supporter 13 and piston rod of said steering cylinder are in rotary connection with each other via a bearing; said upper cradle 7 is fixedly arranged on said rotary disk 23; one of the ends of said steering cylinder 10 is articulated with said rotary disk 23, while the other end of said steering cylinder 10 is articulated with said frame 2 via an abutment 21. This structure enables 0-90 degree of the rotation angle of said replacement machine in place, (FIG. 9) and makes said bridge deck replacement machine easy to turn, so as to facilitate its transverse and longitudinal movement.

Said bridge deck replacement machine further comprises an electro-hydraulic control system 3, and said electro-hydraulic control system 3 controls the ascending and descending of said bridge deck supporting means and said moving unit, and the turning of said moving unit. The electro-hydraulic control system 3 also controls the balance of said frame 2, through controlling the working of said balance hydro-cylinder 9 of said frame three-point balance supporting system.

In order to remove a bridge deck from the piers, said bridge deck replacement machine needs to be taken to the position close to said piers, referring to FIG. 2. When said bridge deck replacement machine is at empty load, only wheels 15 at the ends of said bridge deck replacement machine land on the ground and other wheels are lifted up to get separated from the ground, in order to reduce the friction force as the machine is running (FIG. 10)

Referring to FIG. 3, the removal of a bridge deck using the bridge deck replacement machine is conducted through the steps as follows:
a. the working of each said main lift cylinder 1 via said electro-hydraulic system 3 to adjust the ascending and balance of said fixed bracket 5; meanwhile, the electro-hydraulic control system 3 also controls the balance of said frame 2, through controlling the working of said balance hydro-cylinder 9 of said frame three-point balance supporting system.
b. jacking a bridge deck via said fixed bracket 5, in order to remove said bridge deck from said piers;
c. controlling the working of said main lift cylinder 1 via said electro-hydraulic control system 3 to adjust the descending and balance of said fixed bracket 5; meanwhile, the electro-hydraulic control system 3 also controls the balance of said frame 2, through controlling the working of said balance hydro-cylinder 9 of said frame three-point balance supporting system.

### Example 2

Referring to FIG. 5-6, a bridge deck replacement machine unit, consisting of two bridge deck replacement machines in transverse fixed connection to each other, wherein, said bridge deck replacement machine comprises a frame 2, a bridge deck supporting means arranged on the top of said frame 2, and a moving unit; said bridge deck replacement machine has six sides which consists of a top surface and a bottom surface, two transverse sides opposite to each other, and two longitudinal sides opposite to each other.

Wherein, a transverse connection saddle 61 is arranged on the transverse side of said frame 2 for forming a transverse connection between two bridge deck replacement machines In addition, a longitudinal connection saddle 62 is arranged on the transverse side of said frame 2 for forming a longitudinal connection between two bridge deck replacement machines.

Each said bridge deck supporting means comprises a fixed bracket 5, and two main lift cylinders 1; said main lift cylinder 1 has a first end and a second end which is opposite to said first end; said first end of said main lift cylinder 1 is in fixed connection with said frame 2, while the piston rod 19 at said second end of said main lift cylinder 1 is in fixed connection with the bottom surface of said fixed bracket 5. The two main lift cylinders 1 of one of the bridge deck replacement machines are connected to a first closed loop oil circuit to form a fulcrum, and the main lift cylinders 1 of each of the rest bridge deck replacement machines are respectively connected to a first closed loop oil circuit to form another two fulcrums. Three fulcrums form a fixed bracket three-point balance supporting system for controlling the ascending, descending and balance of said fixed brackets 5.

Said moving unit comprises six wheel mechanisms; each said wheel mechanism comprises wheels, a connecting link mechanism arranged between the bottom surface of said frame 2 and the axle 14 of said wheel, and a balance hydro-cylinder 9 for controlling the ascending and descending of the wheels of said wheel mechanism via controlling the extension and retraction of said connection link mechanism. In this example of the bridge deck replacement machine unit, wherein, all the balance hydro-cylinders 9 of one of the bridge deck replacement machines are connected to a second closed loop oil circuit, and the balance hydro-cylinders 9 of the other bridge deck replacement machines are divided into two groups; each group of balance hydro-cylinders 9 forms a fulcrum, and the three group of balance hydro-cylinders 9 form a frame three-point balance supporting system for keeping the balance of said frame 2.

Referring to FIG. 15, each said connecting link mechanism comprises a upper cradle 7 and a lower cradle 8 arranged on the bottom surface of said frame 2, the upper end of said lower cradle 8 is in flexible connection with the lower end of said upper cradle 7; the lower end of said lower cradle is in flexible connection with said axle 14, and the upper end of said upper cradle 7 is longitudinally articulated with said frame 2 via a swing mechanism 20; one of the ends of said balance hydro-cylinder 9 is in flexible connection with the upper end of said upper cradle 7, and the piston rod 17 at the other end of said balance hydro-cylinder 9 is in flexible connection with the lower end of said lower cradle 8.

Referring to FIG. 14 and FIG. 15, each said swing mechanism 20 comprises a steering cylinder 10, a rotary disk 23 and bearing supporter 13; said bearing supporter 13 is fixed on the bottom surface of said frame 2, said rotary disk 23 and said bearing supporter 13 are in rotary connection with each other via a bearing; said upper cradle 7 is fixed on said rotary disk 23; one of the ends of said steering cylinder 10 is articulated with said rotary disk 23, while the piston rod 18 at the other end of said steering cylinder 10 is articulated with said frame 2 via an abutment 21. This structure enables 0-90 degree of the rotation angle of said replacement machine in place, (FIG. 9) and makes said bridge deck replacement machine easy to turn, so as to facilitate its transverse and longitudinal movement.

Said bridge deck replacement machine further comprises an electro-hydraulic control system 3, and said electro-hydraulic control system 3 controls the ascending and descending of said bridge deck supporting means and said moving unit, and the turning of said moving unit. The electro-hydraulic control system 3 also controls the balance of said frame 2 through controlling the working of said balance hydro-cylinders 9 of said frame three-point balance supporting system.
In order to assemble a bridge deck on the piers, said bridge deck replacement machine needs to carry a bridge deck that has been constructed to the position close to said piers. When said bridge deck replacement machine is on load, all the wheels including wheels 15 land on the ground, in order to provide enough support to said bridge deck replacement machine.

The assembling of a bridge deck using the bridge deck replacement machine is conducted through the steps as follows:
a. controlling the working of each said main lift cylinder 1 of said fixed bracket balance supporting system via said electro-hydraulic system 3 to adjust the ascending and balance of said fixed bracket 5 carrying a bridge deck; meanwhile, controls the working of balance hydro-cylinders 9 by said electro-hydraulic control system 3 via said electro-hydraulic system 3 to adjust the balance of said frame 2.
b. placing said bridge deck on said piers;
c. controlling the working of said main lift cylinder 1 via said electro-hydraulic control system 3 to adjust the descending and balance of said fixed bracket 5; meanwhile, controls the working of balance hydro-cylinders 9 by said electro-hydraulic control system 3 via said electro-hydraulic system 3 to adjust the balance of said frame 2.
d. taking the bridge deck replacement machine away from the position of said piers, so as to complete the assembling of said bridge deck.

### Example 3

Referring to FIG. 4, a bridge deck replacement machine unit is constituted by two bridge deck replacement machines in longitudinal connection together, wherein the structure of each bridge deck replacement machine is the same as the one introduced in example 2. And the way of working of said bridge deck replacement machine unit is the same as that introduced in example 2.

### Example 4

Referring to FIG. 7-FIG. 8, a bridge deck replacement machine unit, consists of four bridge deck replacement units in transverse or longitudinal fixed connection to each other, and each unit comprises two bridge deck replacement machines fixedly connected to each other. Said bridge deck replacement machine comprises a frame 2, a bridge deck supporting means arranged on the top of said frame 2, and a moving unit; said bridge deck replace machine has six sides which consists of a top surface and a bottom surface, two transverse sides opposite to each other, and two longitudinal sides opposite to each other.

Wherein, a transverse connection saddle 61 and a longitudinal connection saddle 62 are arranged on the transverse sides of said frame 2. Each two adjacent said bridge deck replacement machines are in transverse removable fixed connection or longitudinal removable fixed connection with each other through the connection girder 16 and the flanges.

Each said bridge deck supporting means comprises a fixed bracket 5, and two main lift cylinders 1; each said main lift cylinder 1 has a first end and a second end which is opposite to said first end; said first end of said main lift cylinder 1 is in fixed connection with said frame 2, while the piston rod 19 at said second end of said main lift cylinder 1 is in fixed connection with the bottom surface of said fixed bracket 5; The main lift cylinders 1 of two of the bridge deck replacement machines are connected to a first closed loop oil circuit to form a fulcrum, and the main lift cylinders 1 of each of the other bridge deck replacement machines are connected to a first closed loop oil circuit to a fulcrum. Three fulcrums form a fixed bracket three-point balance supporting system for controlling the ascending, descending and balance of said fixed brackets 5.

Each said moving unit comprises six wheel mechanism; said wheel mechanism comprises wheels, a connecting link mechanism arranged between the bottom surface of said frame 2 and the axle 14 of said wheel, and more than three balance hydro-cylinders 9 for controlling the ascending and descending of the wheels of said wheel mechanism via controlling the extension and retraction of said connection link mechanism. In this example of the bridge deck replacement machine unit, wherein, all the balance hydro-cylinders 9 of two of the bridge deck replacement machines are connected to a second closed loop oil circuit to form a fulcrum, and the balance hydro-cylinders 9 of the other bridge deck replacement machines are divided into two groups; each group of balance hydro-cylinders 9 forms a fulcrum, and the three fulcrums form a frame three-point balance supporting system for keeping the balance of said frames 2.

Referring to FIG. 15, said connecting link mechanism comprises a upper cradle 7 and a lower cradle 8 arranged on the bottom surface of said frame 2, the upper end of said lower cradle 8 is in flexible connection with the lower end of said upper cradle 7; the lower end of said lower cradle is in flexible connection with said axle 14, and the upper end of said upper cradle 7 is longitudinally articulated with said frame 2 via a swing mechanism 20; one of the ends of said balance hydro-cylinder 9 is in flexible connection with the upper end of said upper cradle 7, and the piston 17 at the other end of said balance hydro-cylinder 9 is in flexible connection with the lower end of said lower cradle 8.

Referring to FIG. 14, said swing mechanism 20 comprises a steering cylinder 10, a rotary disk 23 and bearing supporter 13; said bearing supporter 13 is fixed on the bottom surface of said frame 2, said rotary disk 23 and said bearing supporter 13 are in rotary connection with each other via a bearing; said upper cradle 7 is fixed on said rotary disk 23; one of the ends of said steering cylinder 10 is articulated with said rotary disk 23, while the piston rod 18 at the other end of said steering cylinder 10 is articulated with said frame 2 via an abutment 21. This structure enables 0-90 degree of the rotation angle of said replacement machine in place, (FIG. 9) and makes said bridge deck replacement machine easy to turn, so as to facilitate its transverse and transverse movement.

Said bridge deck replacement machine unit further comprises an electro-hydraulic control system, and said electro-hydraulic control system controls the ascending and descending of said bridge deck supporting means and said moving unit, and the turning of said moving units. The electro-hydraulic control system also controls the balance of said frame 2 via controlling the working of the balance hydro-cylinder 9 of said frame three-point balance supporting system.

One of the said bridge deck replacement machine units is equipped with a tractor connector 24 for connecting with a tractor 4.

In order to remove a bridge deck from the piers, a tractor 4 needs to be connected to said tractor connector 24. Said bridge deck replacement machine is taken to the position close to said piers by said tractor 4.

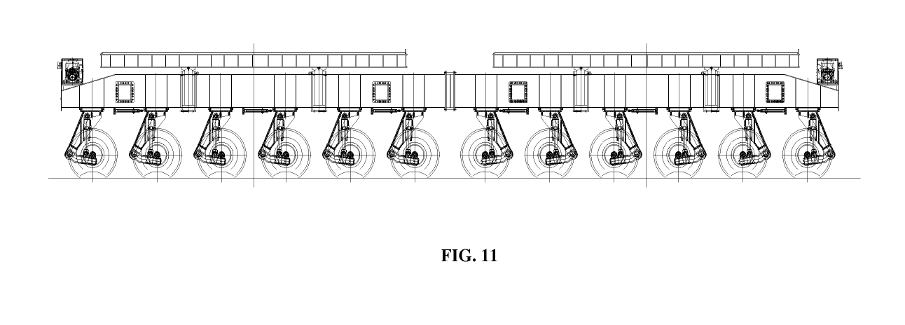

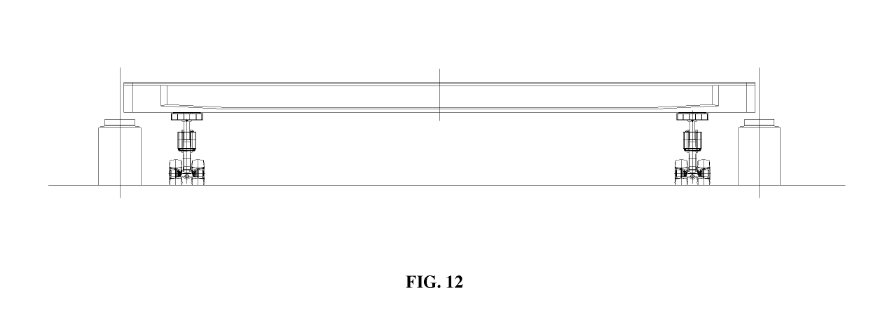

When said bridge deck replacement machine is at empty load, only wheels 15 at the ends of said bridge deck replacement machine land on the ground and other wheels are lifted up to get separated from the ground, in order to reduce the friction force when the machine is running. The movement of the wheels is controlled by the electro-hydraulic control system 3 which receives the command sent from a person via a remote controller. Referring to FIG. 10 and FIG. 11, all the wheels including wheels 15 land on the ground, in order to provide enough support to said bridge deck replacement machine. Then, the bridge deck replacement machine unit is taken by a tractor to the position close to the piers.

The removal of a bridge deck using the bridge deck replacement machine unit is conducted through the steps as follows:
a. controlling the working of said main lift cylinder 1 of said fixed bracket three-point balance supporting system via said electro-hydraulic system 3 to control the ascending and balance of said fixed bracket 5; meanwhile, said electro-hydraulic control system 3 controls the working of said balance hydro-cylinder 9 of said frame three-point balance supporting system to control the balance of said frame 2.
b. Jacking a bridge deck via said fixed bracket 5, in order to remove said bridge deck from said piers;
c. controlling the working of said main lift cylinder 1 of said fixed bracket three-point balance supporting system via said electro-hydraulic system 3 to control the descending and balance of said fixed bracket 5; meanwhile, said electro-hydraulic control system 3 controls the working of said balance hydro-cylinder 9 of said frame three-point balance supporting system to control the balance of said frame 2.
d. taking the bridge deck replacement machine away from the position of said piers via the tractor 4, so as to complete the removal of said bridge deck, meanwhile, landing all the wheels lifted on the ground through the balance hydro-cylinders 9 controlled by said electro-hydraulic control system 3 which receives the command sent from a person via a remote controller. (FIG. 11)

### Example 5

There is also an alternative way of bridge deck replacement using two said bridge deck replacement machine units of example 2 or 3 which are in electro-hydraulic connection to each other forming a bridge deck replacement machine group.

Wherein, the main lift cylinders 1 of one of the bridge deck replacement machine units are connected to a first closed loop oil circuit to form a fulcrum; the mail lift cylinders 1 of the other bridge deck replacement machine unit are divided into two groups, and each group of main lift cylinders 1 are connected to a first closed loop oil circuit to form a fulcrum respectively; all the main lift cylinders 1 form a fixed bracket three-point balance supporting system.

The balance hydro-cylinders 9 of one of the bridge deck replacement machine units are connected to a second closed loop oil circuit to form a fulcrum; the balance hydro-cylinders 9 of the other bridge deck replacement machine unit are divided into two groups, and each group of balance hydro-cylinders 9 are connected to a second closed loop oil circuit to form a fulcrum respectively; all the balance hydro-cylinders form a frame three-point balance supporting system.

The removal of a bridge deck using the bridge deck replacement machine unit is conducted through the steps as follows:
a. controlling the working of said main lift cylinder 1 of said fixed bracket three-point balance supporting system via said electro-hydraulic system 3 to control the ascending and balance of said fixed bracket 5; meanwhile, said electro-hydraulic control system 3 controls the working of said balance hydro-cylinder 9 of said frame three-point balance supporting system to control the balance of said frame 2.
b. Jacking a bridge deck via said fixed bracket 5, in order to remove said bridge deck from said piers;
c. controlling the working of said main lift cylinder 1 of said fixed bracket three-point balance supporting system via said electro-hydraulic system 3 to control the descending and balance of said fixed bracket 5; meanwhile, said electro-hydraulic control system 3 controls the working of said balance hydro-cylinder 9 of said frame three-point balance supporting system to control the balance of said frame 2.
d. taking the bridge deck replacement machine away from the position of said piers via the tractor 4, so as to complete the removal of said bridge deck, meanwhile, landing all the wheels lifted on the ground through the balance hydro-cylinders 9 controlled by said electro-hydraulic control system 3 which receives the command sent from a person via a remote controller. (FIG. 11) The electro-hydraulic control system has a command module for receiving and sending the command from said remote controller.
When the bridge deck is in large size and weight, a number of said bridge deck replacement machines have to be used, in order to ensure that the bridge deck can be jacked up. In order to improve the stability and easiness of controlling when jacking or supporting the bridge deck with large size and weight, a bridge deck replacement machine group that is constituted by several above mentioned bridge deck replacement machine units transversely and longitudinally fixedly connected together through connecting devices and controlled by an electro-hydraulic control system is a very effective way to achieve the goal of replacing a bridge deck (FIG. 10-FIG. 12).

What is claimed is:

1. A bridge deck replacement machine, comprising a frame (2), bridge deck supporting means arranged on the top of the frame (2), and a moving unit arranged under the frame (2); wherein, said bridge deck supporting means comprises a fixed bracket (5) and a main lift cylinder (1); said main lift cylinder (1) has a first end and a second end which is opposite to said first end; said first end of said main lift cylinder (1) is in fixed connection with said frame (2), while said second end of said main lift cylinder (1) is in fixed connection with the bottom surface of said fixed bracket (5); at least one connection saddle for fixedly connecting to a connecting girder (16) is arranged on the side of said frame; said bridge deck replacement machine further comprises an electro-hydraulic control system, and said electro-hydraulic control system controls the movement of said bridge deck supporting means.

2. The bridge deck replacement machine of claim 1, wherein, said moving unit consists of two wheel mechanisms (25); said wheel mechanism comprises wheels, a connecting link mechanism arranged between the bottom surface of said frame (2) and the axle (14) of said wheel, and a balance hydro-cylinder (9) for controlling the ascending and descending of the wheels of said wheel mechanism via controlling the movement of said connection link mechanism.

3. The bridge deck replacement machine of claim 2, wherein, said connecting link mechanism comprises a upper cradle (7) arranged on the bottom surface of said frame (2), and a lower cradle (8), the upper end of said lower cradle (8) is in flexible connection with the lower end of said upper cradle (7); the lower end of said lower cradle (8) is in flexible connection with said axle (14), and the upper end of said upper cradle (7) is longitudinally articulated with said frame (2) via a swing mechanism (20); one of the ends of said balance hydro-cylinder (9) is in flexible connection with the upper end of said upper cradle (7), and the other end of said balance hydro-cylinder (9) is in flexible connection with the lower end of said lower cradle (8).

4. The bridge deck replacement machine of claim 3, wherein, said swing mechanism (20) comprises a steering cylinder (10), a rotary disk (23) and bearing supporter (13); said bearing supporter (13) is fixed on the bottom surface of said frame (2), said rotary disk (23) and said bearing supporter (13) are in rotary connection with each other via a bearing; said upper cradle (7) is fixed on said rotary disk (23); one of the ends of said steering cylinder (10) is articulated with said rotary disk (23), while the other end of said steering cylinder (10) is articulated (articulated) with said frame (2) via an abutment (21).

5. The bridge deck replacement machine of claim 1, wherein, said connection saddle is a transverse connection saddle (61) set on the transverse side of said frame (2) for forming a transverse connection between each two bridge deck replacement machines.

6. The bridge deck replacement machine of claim 1, wherein, said connection saddle is a longitudinal connection saddle (62) arranged on the longitudinal side of said frame (2) for forming a longitudinal connection between each two bridge deck replacement machines.

7. The bridge deck replacement machine of claim 1, wherein, the number of said connection saddles is more than two, one of which is a transverse connection saddle (61) arranged on the transverse side of said frame (2) and the other of which is a longitudinal connection saddle (62) arranged on the longitudinal side of said frame (2), for forming a transverse connection and a longitudinal connection among said bridge deck replacement machines.

8. A bridge deck replacement machine unit constituted by at least two above mentioned bridge deck replacement machines of claim 1, wherein, said bridge deck replacement machine unit is constituted by at least two above mentioned bridge deck replacement machines fixedly connected to each other via said connecting girder (16); each end of said connecting girder (16) is in fixed connection to the connecting saddle of adjacent said bridge deck replacement machine; said electro-hydraulic control system (3) controls the ascending and descending of said bridge deck supporting means, or turning of said moving unit.

9. A bridge deck replacement machine unit of claim 8, wherein, said electro-hydraulic control system (3) controls the ascending and descending of said bridge deck supporting means, and turning of said moving unit.

10. The bridge deck replacement machine unit of claim 8, wherein, said fixed connection is a removable connection.

11. A method of bridge deck replacement using the bridge deck replacement machine of claim 1 or the bridge deck replacement machine unit in claim 8, wherein comprising the steps of:
a. controlling the working of each said main lift cylinder (1) via said electro-hydraulic system (3) to adjust the ascending and balance of said fixed bracket (5);
b. Jacking a bridge deck via said fixed bracket (5), in order to remove or assemble said bridge deck;
c. controlling the working of said main lift cylinder (1) via said electro-hydraulic control system (3) to adjust the descending and balance of said fixed bracket (5).

12. The method of bridge deck replacement of claim 11, wherein, the number of said main lift cylinders (1) is more than three; each said main lift cylinder (1) is respectively connected to a first closed loop oil circuit via an oil circuit interface, forming a fixed bracket three-point balance supporting system; said electro-hydraulic control system (3) controls the working of said main lift cylinder (1) of said fixed bracket three-point balance supporting system to adjust the ascending, descending and balance of said fixed bracket (5).

13. The method of bridge deck replacement of claim 12, wherein, the number of said balance hydro-cylinders (9) is more than three; each said balance hydro-cylinder (9) is respectively connected to a second closed loop oil circuit via an oil circuit interface, forming a frame three-point balance supporting system; said electro-hydraulic control system (3) controls the working of said balance hydro-cylinders (9) of said frame three-point balance supporting system to adjust the balance of said frame (2).

14. The method of bridge deck replacement using said bridge deck replacement machine or said bridge deck replacement machine unit of claim 13; wherein,
at least two said bridge deck replacement machine units are connected to each other in parallel, constituting a bridge deck replacement machine group; at least one said bridge deck replacement machine unit is equipped with at least one tractor connector (24);
said electro-hydraulic control system (3) controls the ascending, descending and balance of said fixed bracket (5) through controlling the working of said mail lift cylinders (1) of said fixed bracket three-point supporting system, in order to remove a bridge deck from the piers, or assemble a bridge deck on the piers;
said electro-hydraulic control system (3) also controls the balance of said frame (2) through controlling the working of said balance hydro-cylinder (9) of said frame three-point balance supporting system.
